(19) United States
(12) Patent Application Publication
(10) Pub. No.: US 2003/0037324 A1
(43) Pub. Date: Feb. 20, 2003

(54) Profile management for upgrade utility

(75) Inventors: James Kong, Castrovalley, CA (US); Vsevolod Sebastian Kamyshenko, Mountain View, CA (US); Alexandre Kravtchenko, Sunnyvale, CA (US)

Correspondence Address: HOGAN & HARTSON LLP, IP GROUP, COLUMBIA SQUARE, 555 THIRTEENTH STREET, N.W., WASHINGTON, DC, 20004, US

(73) Assignee: Sun Microsystems, Inc. and Netscape Communications Corporation

(21) Appl. No.: 09/931,037

(22) Filed: Aug. 17, 2001

(51) Int. Cl. G06F 9/44; G06F 17/60

(52) U.S. Cl. 717/173; 705/1

(57) ABSTRACT

A system and method for upgrading software application is disclosed. The system provides a profile upgrade utility that generates a profile of desired application upgrades based upon information provided from a user. In operation, a user may provide a description of modules for upgrade, along with any associated components and a description of the module location. Using this information, the system generates a profile of the desired upgrade. The upgrade profile is then converted to a text file and uploaded to an import/export utility that retrieves the requested upgrades.

### BACKGROUND OF THE INVENTION

1. Field of the Invention

The invention relates to a software upgrade utility. More particularly, the invention relates to a method and system allowing dynamic upgrading of software applications.

2. Description of the Related Art

In the software field, developers create version upgrades or individual upgrades on a regular basis. These upgrades are generally stored on a storage media, such as a floppy disk or CD ROM and are then distributed to software users manually or over a network. In this system, software upgrades must be properly distributed to users and those users must properly install the upgrades. Similarly, individual software applications may also be upgraded. This technique for upgrading software applications requires that the upgrades are distributed in a prompt and efficient manner and further requires that users take the appropriate steps to install the upgrades onto their systems.

In e-commerce environments, data is often stored in distributed databases accessible via the World Wide Web (WWW) or the case of smaller networks, databases that can be accessed via a local area network (LAN). Data may be stored as business objects, which are resources for a given e-commerce application. Business objects may include particular data such as pricing information, payment information, product information, shipping information, etc. These business objects, which form the rules governing e-commerce transactions, are frequently updated depending on changes in the commercial environment. For example, changes in product type and cost or changes in available product distribution networks may all require the updating of the business objects.

In many instances, operators of e-commerce sites may want to upgrade particular utilities, such as those that are known to require frequent upgrading, or others that are designated as mission critical. In the current e-commerce systems, there are no mechanisms by which an operator can define which upgrade utilities are needed and which modules these upgrades are intended for. Thus, e-commerce operators have difficulty obtaining required upgrades.

### SUMMARY OF THE INVENTION

Thus, in view of the difficulties that e-commerce providers face, there is a need for a system and method for upgrading software applications that allows for simplified application designation. The invention solves the problems of conventional e-commerce applications by providing a profile upgrade utility module that is capable of developing a profile of the desired business objects as well receive user information relating to the specific modules for which an upgrade is desired. Thus, the profile upgrade utility in accordance with the invention is able to develop a profile for modules requiring an upgrade and then communicate with an import/export utility module that receives request and retrieves the appropriate upgrade.

The invention allows user to dynamically upgrade e-commerce applications, including user, catalog, workflow, accounting code and order management data. In addition, information relating to specific orders and order histories, as well as site specific customizations may be obtained.

The invention provides a solution to the problems with the conventional mechanisms for upgrading software applications. In particular, the invention provides a system and method for dynamically providing software upgrades in real-time over a network system.

The invention provides for generating a profile of the application for which an upgrade is requested. The profile can specify the environment in which the application operates, including the data source, and the nature of the module to be upgraded. In addition, the user may specify the task for which the application is requested.

It is to be understood that both the foregoing general description and the following detailed description are exemplary and explanatory and are intended to provide further explanation of the invention as claimed.

### BRIEF DESCRIPTION OF THE DRAWINGS

FIG. 1 shows a block diagram of the profile utility upgrade module in accordance with an embodiment of the invention coupled to a import/export utility module;

FIG. 2 shows the profile utility upgrade module of FIG. 1 in greater detail;

FIG. 3 shows the modules available for upgrade in accordance with an embodiment of the invention;

FIG. 4 shows a screen shot of a profile selection query in accordance with an embodiment of the invention;

FIG. 5 shows a screen shot of a module selection query in accordance with an embodiment of the invention;

FIG. 6 shows a screen shot of component selection query in accordance with an embodiment of the invention;

FIG. 7 shows a screen shot of a profile configuration query in accordance with an embodiment of the invention;

FIG. 8 shows a screen shot of a run/stop/resume query in accordance with an embodiment of the invention;

FIG. 9 shows a screen shot of a status indication screen in accordance with an embodiment of the invention;

FIG. 10 shows a screen shot of a report request screen in accordance with an embodiment of the invention.

FIG. 11 illustrates the process for developing a profile of desired application upgrades in accordance with an embodiment of the invention.

### DETAILED DESCRIPTION OF THE PREFERRED EMBODIMENTS

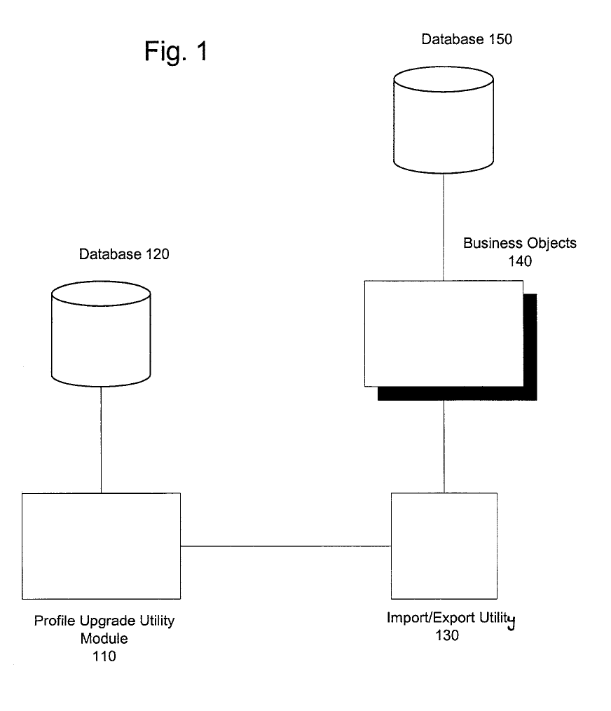

FIG. 1 shows the system for upgrading utilities in accordance with an embodiment of the invention. FIG. 1 shows a profile utility upgrade module 110 communicatively coupled to a database 120. The profile utility upgrade module 110 is also coupled to an import/export utility module 130. The import/export utility module 130 is coupled a business objects module 140. The business objects module 140 is also coupled to a database 150. A user may access the profile upgrade utility module 110 and import/export utility module 130 functionality using an internet browser through a graphical user interface (GUI) or a command line interface.

In operation, a user attempting to upgrade one or more software applications accesses the profile upgrade utility module 110 via a user interface. As will be described in greater detail below, the profile upgrade utility module 110 presents the user with an upgrade interface that includes a plurality of queries relating to the types of application upgrades that the particular user desires. The profile upgrade utility module 110 then generates a profile of the user requested utilities based upon the user's responses to the queries. The profile may include information about the upgrades desired by the user, including the desired modules and components for upgrade. Any previously prepared profiles, along with the existing software utilities are stored in the database 120.

The profile is then transmitted to the import/export utility 130 as an import file. Utilizing the generated import file, the import/export utility retrieves the desired business objects 140. The business objects may be written in JAVA, for example, and may contain resources in e-commerce systems, such as payments, units, and credit and user information. Data associated with each of the business objects 140 may be stored in the database 150.

The business objects may be described in a data objects repository (DOR). They may be implemented with three static methods—doImportExport, findByAttributes, and close. The doImportExport is a method to perform a particular import/export command. A name of operation and two lists of parameters are passed to the doImportExport. The business object is responsible for validation of the operation. The second parameter list in the doImportExport may be null since it is important only for updating the operations. The last parameter in each of the lists is an interface to support export operation. The dolmportExport returns null if the operation was successful and an error string if the operation was not successful. If the error string is returned, then the returned error string is put directly into a discard file that will be returned to the user. The findByAttributes supports object references in import files. The findByAttributes receives a list of attributes of the validated object and returns unique object identifier, such as GUID (Globally Unique Identifier), for example, or null if error occurs. The close method notifies the end of the process. The process carried out by the import/export utility module 130 is described in greater detail in the commonly assigned, co-pending patent application entitled, “An Import/Export Utility and A Method of Processing Data Using the Same,” herein incorporated by reference in its entirety.

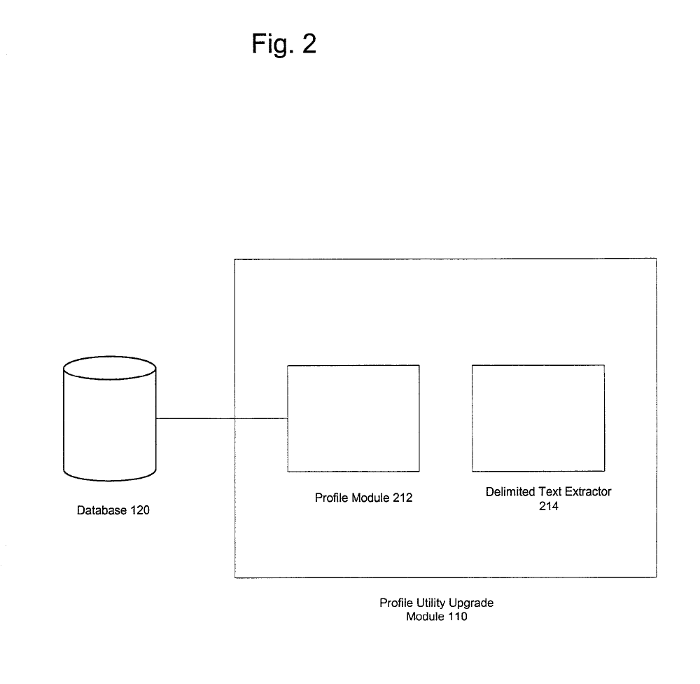

FIG. 2 shows the profile upgrade utility module 110 in greater detail. As shown in FIG. 2, the profile upgrade utility module 110 includes a profile module 112 and a delimited text extractor 114. The profile module 112 is coupled to the database 120 shown in FIG. 1. The profile upgrade utility module 110 also includes a delimited text extractor 114. In operation, the profile module 112 queries a user regarding the type of upgrades desired as well as the types and locations of the modules to be upgraded. The process by which a user is queried is described in greater detail below. The profile module 112 retrieves the current module information from the database 120.

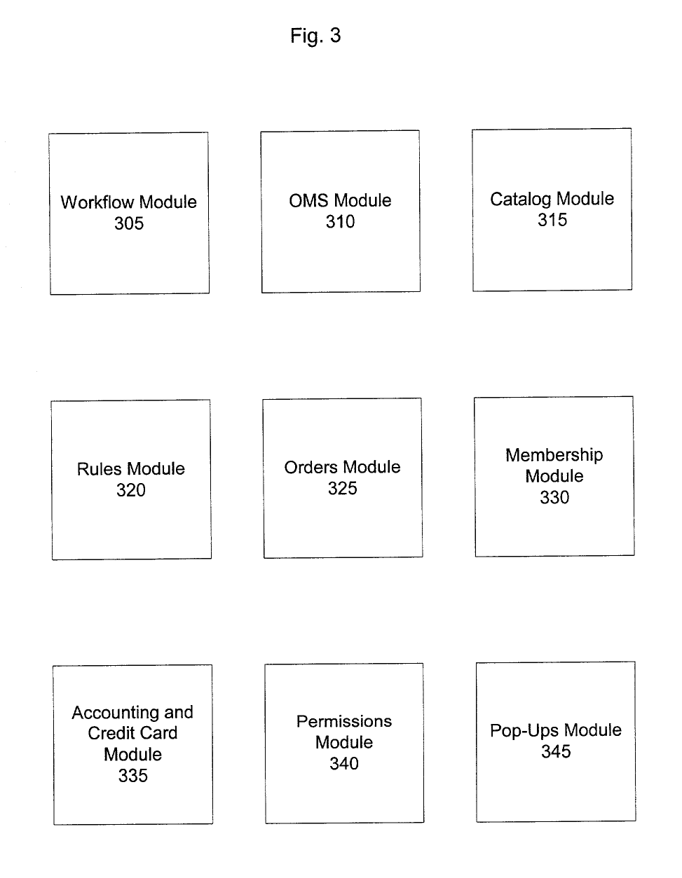

In operation, the profile module 112 generates an upgrade profile based upon user input. The upgrade profile is then sent to the delimited text extractor 114. The delimited text extractor 114 extracts from the profile the type of module to be upgraded, the nature of the upgrade, the location of the module for upgrade, the location of the upgrade, the name and properties of the business object to be invoked to carry out the upgrade and the operation to be performed. This information is transmitted as a text or import file to the import/export utility module 110, as shown in FIG. 3.

FIG. 3 illustrates the types of modules that may be upgraded in accordance with the invention. As shown in FIG. 3, the system will allow for the upgrade of a workflow module 305, an OMS module 310, a catalog module 315, a rules module 320, an orders module 325, a membership module 330, an accounting and commodity codes module 335, a permissions module 340 and a pop-ups module 345. In FIG. 3, the workflow module 305 refers to the general workflow parameters and may include values and descriptions that can be assigned to items in an order requisition. The OMS module 310 refers to product availability, prices, price lists, price adjustments, units, currency units and currency conversions, taxes, credit status, shipping carriers, shipping methods and related information. The catalog module 315 includes a catalog of the goods and/or services offered by the website. The rules module 320 includes the rules governing the decision making processes necessary for carrying out transactions.

The orders module 325, includes a database of orders as well as related information. The membership module 330 includes a database of membership information, such as members and their associated information. The accounting and commodity codes 335 refer to values and information that can be assigned to items in an order requisition. It is important to note that inventions contemplates other modules that may be required for e-commerce applications.

Each of the modules described above includes associated components. The workflow module 305 includes an approver matrix component, a delegations component, a workflow log component, a process definitions component and a process instances and tasks component. The OMS module includes an adjustment component, a price list component, a price column component, a price item component, a price list information component, a unit component, a unit conversion table component, a unit conversion entries component, a ship method component, a freight terms component and a payment terms component.

The catalog module 315 includes a catalog component and a catalog views and permissions component. The rules module 320 includes an accounting code component, a commodity codes component, an interface component, an inventory component, a misc. component, a payment component, a pricing component, a products component, a security component, a shipping component, a tax component and a workflow component. The orders module 325 includes a completed orders component and an in-progress orders component. The membership module 330 includes an organization component, an organization units component, a user groups component, a user's component, and a locations component. The accounting and commodity codes module 335 includes an accounting codes component and a commodity codes component. The permissions module 340 includes a permission levels component and a permission rules component. Each of these components represents a particular application within a selected module.

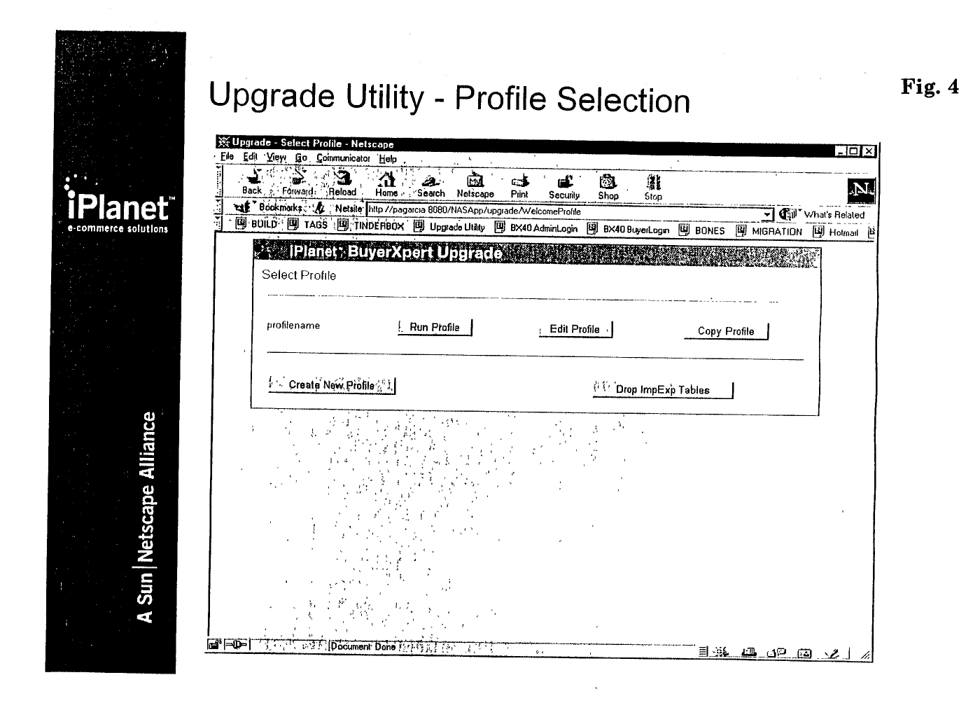

FIG. 4 shows a first screen shot for a profiling session. As shown in FIG. 4, a user is presented with a BuyerXpert Upgrade query querying the user as to whether a new profile should be created, “Create New Profile” 410. The user may also select an existing profile, edit and existing profile and then run the selected profile. If a user has a selected the “Create Profile” 410 option, the system will present the user with an additional interface providing further queries.

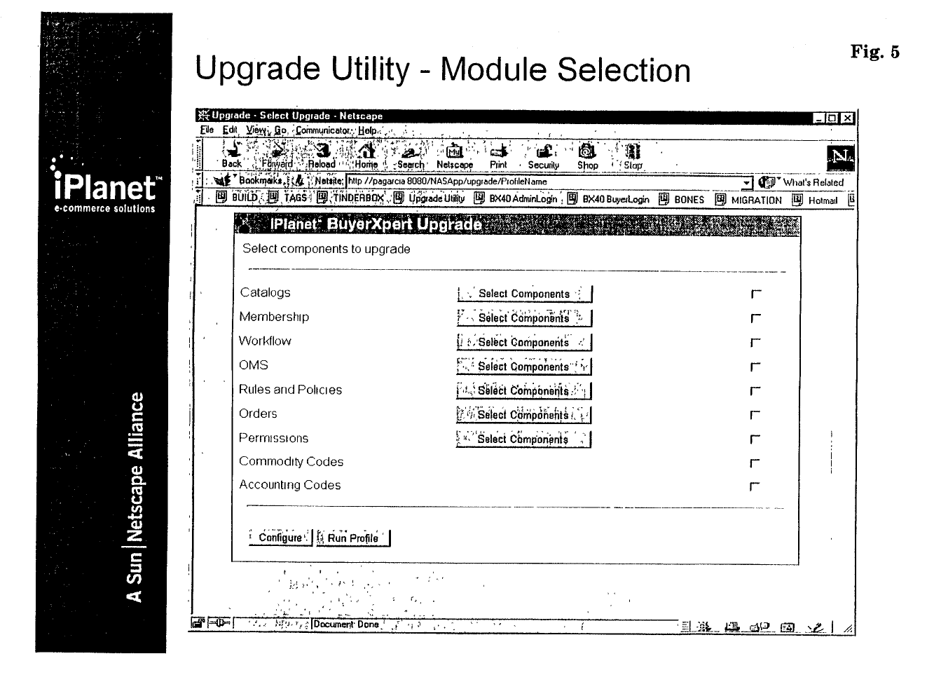

FIG. 5 shows a screen shot for an interface querying the user with respect to which modules are to be upgraded. As shown in FIG. 5, the user is provided with an interface that allows for selection of those modules that a user wants to upgrade. In FIG. 5, a user may select from a catalog module, a membership module, a workflow module, an OMS module, a rules and policies module, an orders module, a permissions module, a commodity codes module and an accounting codes module. Once the user has selected modules for upgrade, the user is then presenting with an interface allowing selection of components for upgrade that correspond to the selected modules.

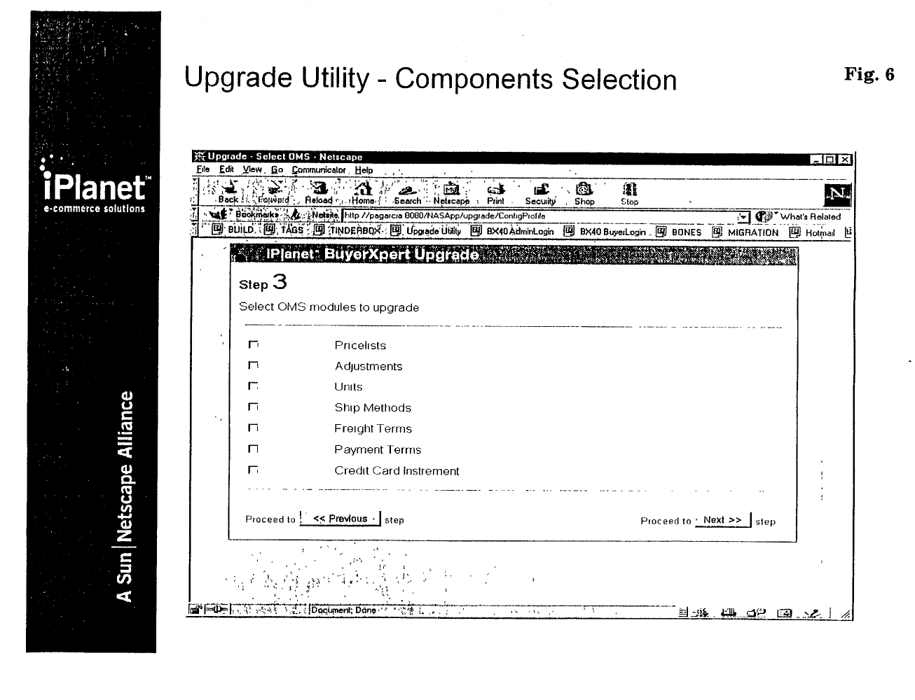

FIG. 6 illustrates an interface for upgrading components associated with the OMS modules. As shown in FIG. 6, the user is presented with the components associated with the selected modules. Thus, in FIG. 6, the user may select from the pricelists component, the adjustments component, the units component, the ship methods component, the freight terms component, the payment terms component and the credit card instruments component. The user may select from any one of these components. Once the user has selected the components for upgrade, the user may select the appropriate site parameters.

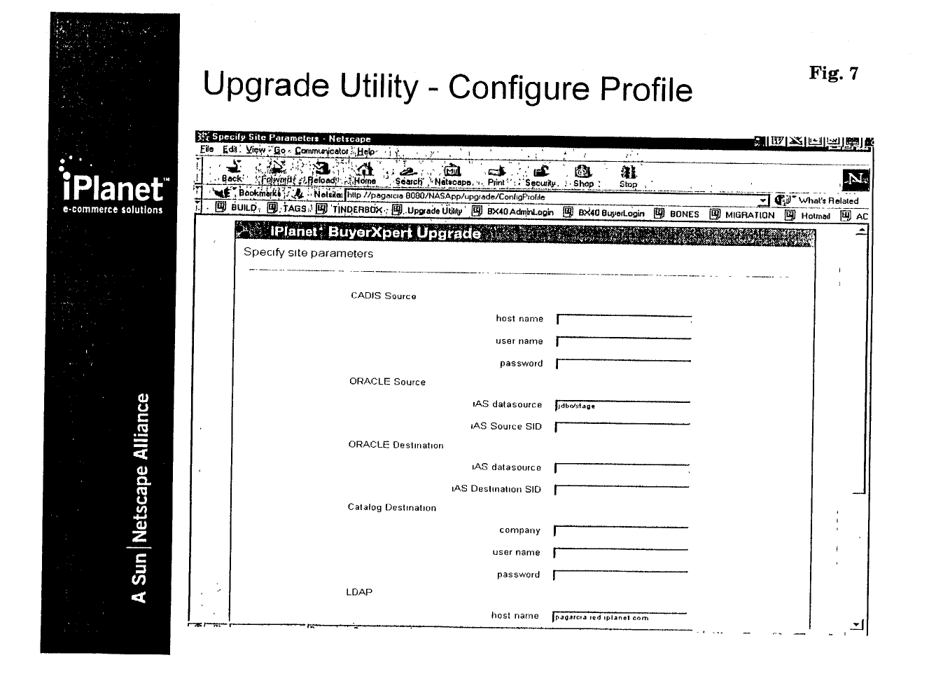

FIG. 7 illustrates an interface in accordance with the invention that allows a user to specify site parameters. Using the interface, the user can indicate the CADIS or ORACLE source along with the destination for the selected upgrades. The source indicates the location of the current modules, i.e., prior to upgrade. The destination indicates the where the upgraded application will reside. Once the source and destination have been selected, the user can determine which modules to run.

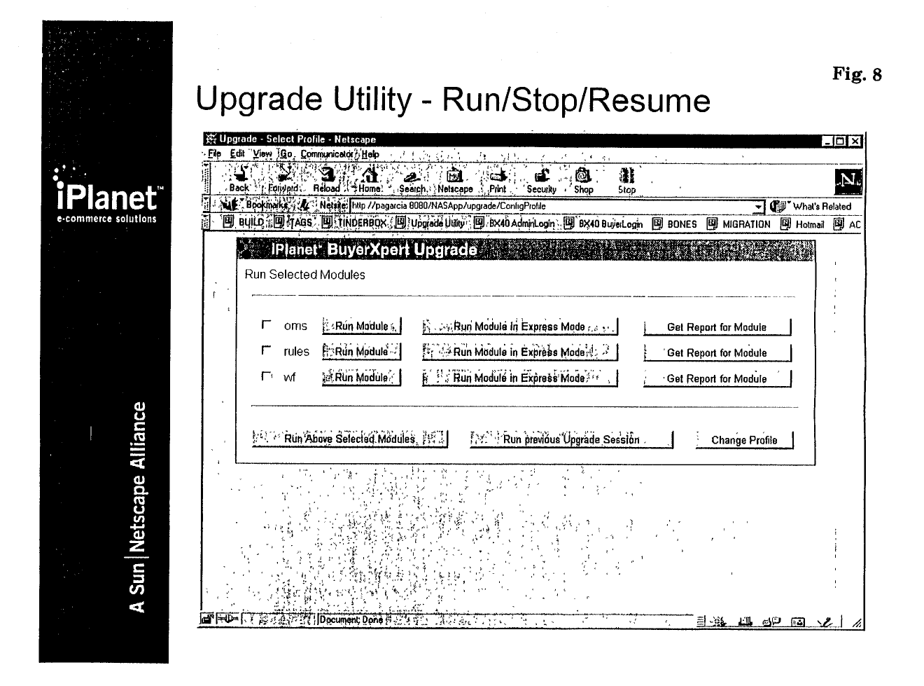

FIG. 8 illustrates an interface presenting the user with the option of either running, or retrieve reports for selected modules. As shown in FIG. 8, the user is presented with the options of “Run Module”, “Run Module in Express Mode” and “Get Report for Module” for each of the modules selected for upgrade. Thus, the user can either request that the module run or request that a report be generated for the module.

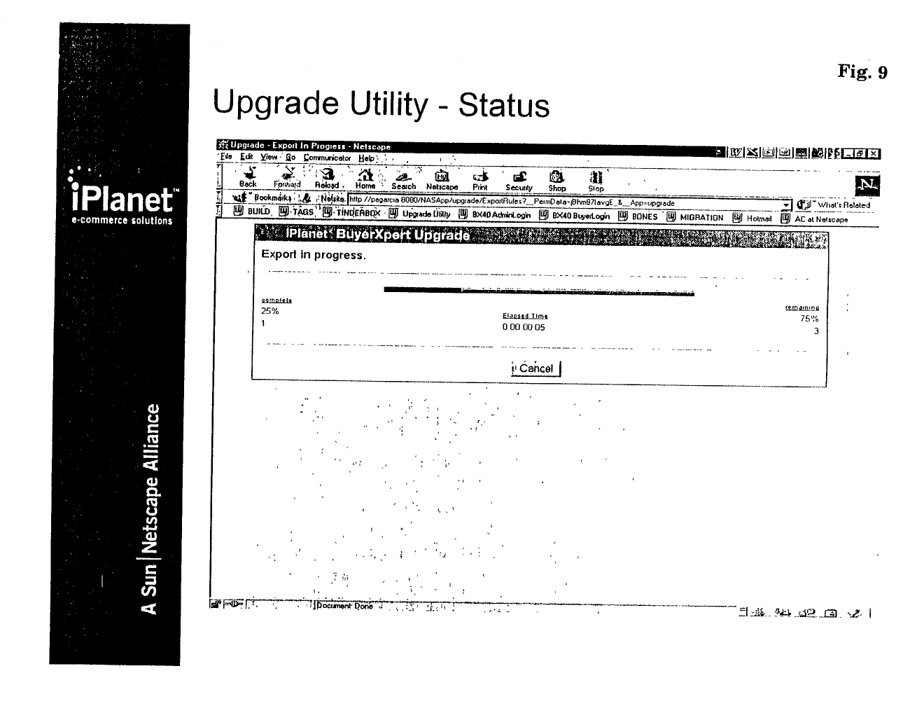

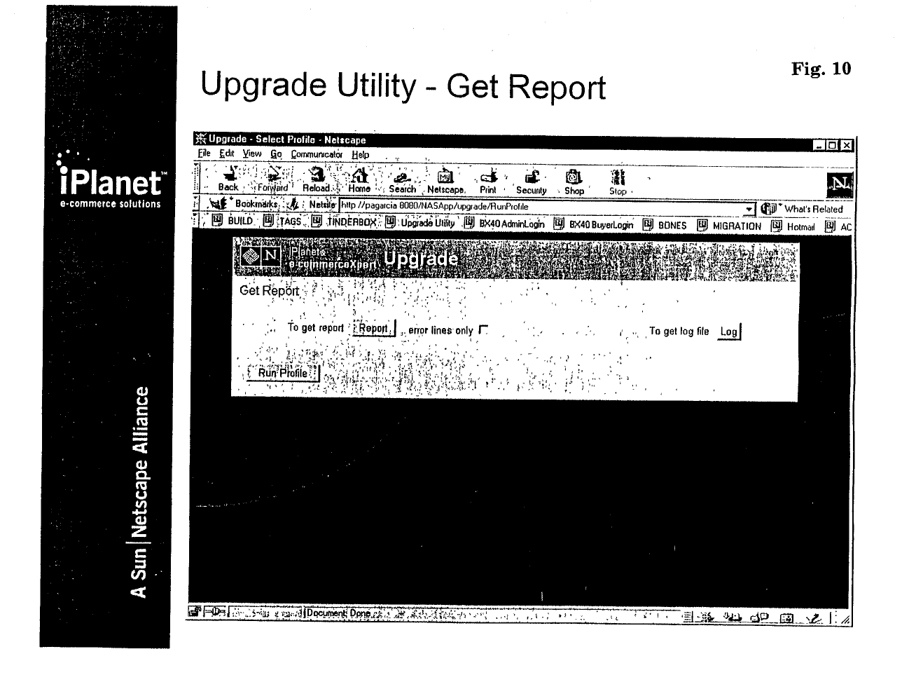

The user will also be presented with a status indicator, indicating the status of the upgrade. As shown in FIG. 9, the system provides the user with a display that indicates how much of the requested upgrade is complete. Finally, as shown in FIG. 10, the system provides the user with an interface for requesting that a report be generated related to the requested upgrades.

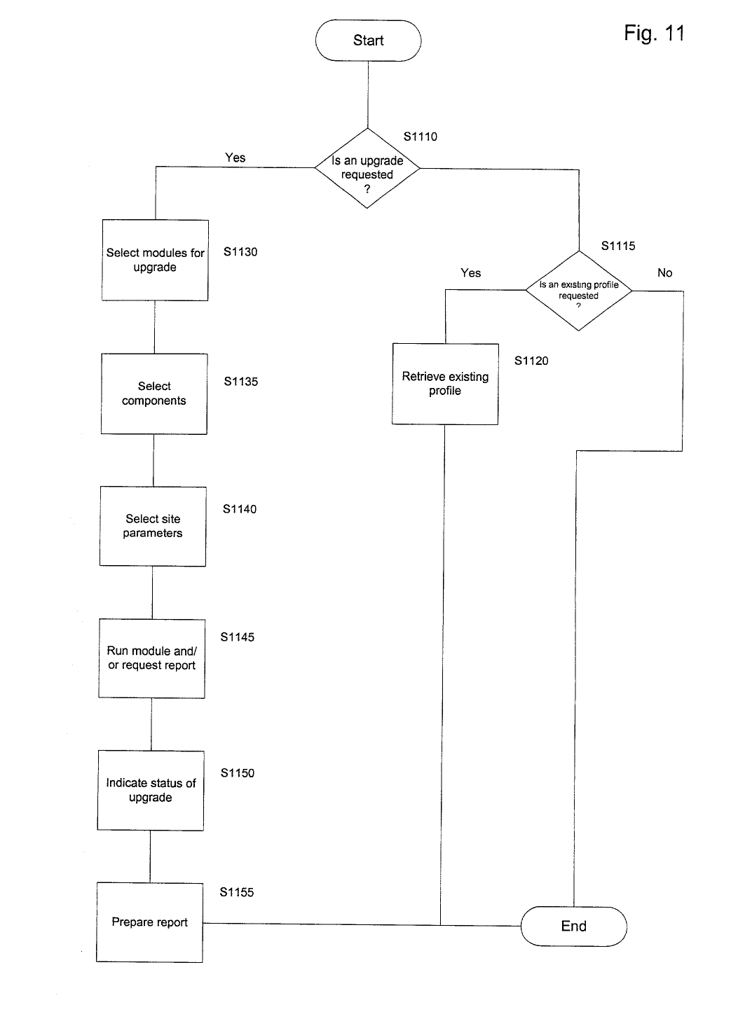

FIG. 11 illustrates the process for dynamically upgrading software utilities in accordance with an embodiment of the invention. As shown in FIG. 11, the process begins with step S1110. In step S1110, the user is queried as to whether an upgrade is desired. If an upgrade is not desired, the process moves to step S1115. In step S1115, the user is queried as to whether an existing profile is desired. If an existing profile is desired, the process ends. Otherwise, if an existing profile is desired, the system moves to step S1120 where an existing profile is retrieved and the process then ends.

If, in step S1110, an upgrade is desired, the process moves to step S1130. In step S1130, the user selects which module or modules require upgrade. As described above, the modules may include a catalogs module, a membership module, a workflow module, a workflow module, an OMS module, a rules and policies module, an orders module, a permissions module, a commodity codes module and an accounting module. Once the user has selected one or more modules for upgrade, the process moves to step S1135.

In step S1135, the user selects the components requiring upgrades based upon the selected modules. As described earlier, each module has a component associated with it. Once the user has selected the component or components for upgrade, the process moves to step S1140.

In step S1140, the user enters the desired site parameters. These may include a CADIS and/or an Oracle source and destination and generally are intended to provide information regarding the location of the existing utilities as well as their respective upgrades. The process then moves to step S1145.

In step S1145, the user determines whether to run the selected module or whether to get a report for the module. In either instance, the process then moves to step S1150. In step S1150, a status indicator is displayed indicating the status of the upgrade, providing an indication of when the upgrade is completed. The process then moves to step S1155.

In step S1155, the user receives a report regarding the upgrade and the process is complete and ends.

It will be apparent to those skilled in the art that various modifications and variations can be made to invention without departing from the spirit or scope of the invention. Thus, it is intended that the present invention covers the modifications and variations of this invention provided that they come within the scope of any claims and their equivalents.

We claim:

1. A method for dynamically upgrading software applications in a distributed network, comprising the steps of:
selecting at least one module for upgrade;
selecting at least one component associated with the at least one module for upgrade;
selecting at least one source and destination site parameter;
generating a profile of at least one upgrade application based upon the selected at least one module, at least one component and at least one source and destination parameter; and
retrieving at least one upgrade application based upon the generated profile.

2. The method according to claim 1, wherein the at least one module is at least one of a workflow module, an OMS module, a catalog module, a rules module, an orders module, a membership module, an accounting and credit card module, a permissions module and a pop-ups module.

3. The method according to claim 1, wherein the at least one module includes at least one associated component.

4. The method according to claim 2, wherein the workflow module is associated with at least one of an approver matrix component, a delegations component, a workflow log component, a process definitions component and a process instances and tasks component.

5. The method according to claim 2, wherein the OMS module is associated with at least one of an adjustment component, a price list component, a price column component, a price item component, a price list information component, a unit component a unit conversion table component, a unit conversion entries component, a ship method component, a freight terms component and a payment terms component.

6. The method according to claim 2, wherein the catalog module is associated with at least one of a catalog component and a catalog views and permissions component.

7. The method according to claim 2, wherein the rules module is associated with at least one of an accounting code component, a commodity codes component, an interface component, an inventory component, a payment component, a pricing component, a products component, a security component, a shipping component, a tax component, and a workflow component.

8. The method according to claim 2, wherein the orders module is associated with at least one of a completed orders component and an in-progress orders component.

9. The method according to claim 2, wherein the membership module is associated with at least one of an organization component, an organization units component, a users group component, a users component and a locations component.

10. The method according to claim 2, wherein the accounting and commodity codes modules is associated with at least one of an accounting codes component and a commodity codes component.

11. The method according to claim 2, wherein the permissions module includes at least one of a permission level component and a permission rules component.

12. The method according to claim 1, wherein the step of generating a profile includes the steps of:
generating an import file; and
downloading the import file to an import/export utility.

13. The method according to claim 12, wherein the import file includes the selected module type information, location information, operation information and business object information.

14. The method according claim 1, further including the step of running the downloaded module upgrade.

15. The method according to claim 1, further including the step of indicating the status of the upgrade.

16. The method according to claim 1, further including the step of generating a report for the at least one upgrade application.

17. The method according to claim 1, wherein the at least one upgrade utility includes at least one business object.

18. A system for dynamically upgrading software applications in a distributed network, that includes a profile utility upgrade module, the profile utility upgrade module comprising:
a profile module for generating an upgrade profile; and
a delimited text extractor module for generating an import file, based upon the upgrade profile.

19. The system according to claim 18, wherein the profile module receives at least one selected module type, a least one selected component type and at least one source and destination parameter.

20. The system according to claim 19, wherein the profile module generates an upgrade profile based upon the at least one selected module type, at least one selected component type and at least one source and destination parameter.

21. The system according to claim 18, wherein the import file is uploaded to an import/export utility.

22. A system for dynamically upgrading software applications in a distributed network, comprising:
means for generating an upgrade profile; and
means for generating an import file based upon the upgrade profile.

23. A computer program product comprising a computer useable medium having computer readable code embodied therein, the computer program product adapted to effect the steps comprising:
receiving at least one module selection;
receiving at least one component selection, the at least one component associated with the at least one module selection;
receiving at least one source and destination parameter; and
generating an upgrade profile based upon the received module selection, component selection and source and destination parameter.
